(19) United States
(12) Patent Application Publication
(10) Pub. No.: US 2006/0209985 A1
(43) Pub. Date: Sep. 21, 2006

(54) Linearization apparatus and method of base station

(75) Inventor: Hyoung-Chang Kang, Seoul (KR)

Correspondence Address: FLESHNER & KIM, LLP, P.O. BOX 221200, CHANTILLY, VA, 20153, US

(73) Assignee: LG-Nortel Co., Ltd.

(21) Appl. No.: 11/296,471

(22) Filed: Dec. 8, 2005

(30) Foreign Application Priority Data
Dec. 15, 2004 (KR) 106000/2004

(51) Int. Cl. H04L 25/49

(52) U.S. Cl. 375/297

(57) ABSTRACT

A linearization apparatus includes a digital transceiver circuit which RF processes a signal from an external source, an amplifier which amplifies an output of the digital transceiver circuit, and a first digital pre-distortion circuit which pre-distorts an output of the amplifier based on an inverse FFT FIR filter estimation based on one or more predetermined parameters. The external source may be an upper channel card of a base station, and the predetermined parameters may include one or more of bulk gain, bulk phase, and bulk delay.

This application claims priority to Korean Patent Application No. 10-2004-0106000, filed in Korea on Dec. 15, 2004, the entire contents of which is incorporated by reference in its entirety.

### BACKGROUND OF THE INVENTION

1. Field of the Invention

The present invention generally relates to communication systems, and more particularly to an apparatus and method.

2. Background of the Related Art

CDMA is a communications technology which maintains multiple wireless connections based on assigned spread-spectrum codes. This technology has advantages because it allows multiple signals to be simultaneously transmitted within a same frequency band. As a result, CDMA techniques have been applied in second-generation mobile communication terminals and used as a basic technique in third-generation mobile communications. An example of an advanced CDMA method used for high-speed data transmission service is the CDMA2000 system.

Structurally, many non-linear components are generated from a radio frequency (RF) end of a CDMA base station. In practice, it has been determined that the non-linear component generated from a chain of power amplifiers and RF up-converters degrades transmission capacity of the base station.

In an effort to solve such problems, methods have been developed to enhance the linearity characteristics of a linear power amplifier (LPA) in the chain. The increased linearity is realized through the use of a feed-forward method. While this technique may guarantee excellent linearity, it has proven to be too expensive, requires repeated manual tuning operations, and has low efficiency. As an alternative, a method for using digital predistortion (DPD) with a high power amplifier (HPA) has been developed. The basic design of the DPD and HPA is as shown in FIG. 1.

FIG. 1 shows the structure of a linearization apparatus used in a CDMA base station in accordance with the related art. This apparatus 100 includes a link field programmable gate array (FPGA) 110, a combiner 120, a DPD 130, a digital quadrature demodulator (DQDM), FPGA 140 and an RF up-converter 150. The link FPGA receives and filters signals coming from an upper channel card of base stations. The combiner 120 combines signals output from the link FPGA. The DPD 130 converts a signal whose power has been amplified with respect to an output of the combiner 120 into a baseband signal, and performs digital predistortion thereon using calculated compensation (distortion). The digital quadrature demodulation (DQDM) FPGA 140 re-aligns data input from the DPD from a front side, synchronizes and outputs it, and samples an intermediate frequency (IF) signal received from a feedback path to double and output it to the DPD. And, the RF up-converter 150 converts the digital signal output from the DQDM FPGA into an analog signal and up-converts it into an RF signal.

Also included is a power amplifier 160 for amplifying an output of the RF up-converter converter 150, and an RF down-converter 170 for converting the analog signal which has been amplified by the power amplifier 160 into a digital signal and for performing frequency down-conversion thereon. Finally, a digital signal processor (DSP) 180 controls the operation of each unit.

In operation, the link FPGA 110 receives a signal from an upper channel card of the base station, filters it, and transfers it to the combiner 120. The combiner then combines respective signals and transfers it to the DPD. The DPD predistorts the signal from the combiner and outputs it to the DQDM FPGA.

The DQDM FPGA 140 re-aligns and synchronizes the input data and outputs it to the RF up-converter 150. The RF up-converter 150 converts the digital signal into an analog signal, up-converts it into an RF signal, and transfers it to the power amplifier 160. The power amplifier then amplifies the RF signal and radiates it over the air interface through an antenna (not shown).

Therefore, RF down-converter 170 receives an analog signal obtained by attenuating an output of the power amplifier 160, converts it into a digital signal, converts it into a baseband signal, and outputs it to the digital predistorter 130. During this time, the RF down-converter continuously monitors and calculates non-linear components generated from the power amplifier and the RF up-converter, and outputs a reversely compensated signal.

FIG. 2 is a graph showing performance measurement results of the linearization apparatus of the related-art CDMA base station. It is noted that the measured performance is excellent, approaching the performance when using the existing LPA, with the lowered inter-modulation distortion (IMD) and high linearity. However, with respect to the efficiency of power amplifier 150, a significant waste factor exists due to excessive backoff.

In the process of performing the digital pre-distortion function adaptively, by feeding back the output of the power amplifier 150 along the feedback path, a highly accurate clocking mechanism which does not even allow for minor errors is required. This proves to be expensive and increases system complexity.

In addition, use of the DPD and HPA is competitive in terms of cost and also increases system complexity. In addition, it is difficult to implement proper performance and continuously maintain performance with these components. Moreover, application of the feedback path as a basic element in the design, increases unit costs for production.

Also, bulk loop gain, bulk phase rotation, bulk time delay and group delay deviation of DPD 130 are initially calculated as constant values. Once the values are calculated, they are not updated any longer.

Additionally, frequency dependent variation, time hysteresis, and memory effect components of power amplifier 160 need continual updating, but their function for reducing error floor by adaptive operation is too small to be mentioned. Thus, if sufficient training time is given to RF up-converter 150 and power amplifier 160, RF down-converter 170 and DSP 180 of the feedback path do not need to be mounted on a circuit board.

Since a limitation of the digital pre-distortion has a close relationship with a clock rate of a digital block, and the DPD function is actually operated in a non-real time basis, compensating for non-linearity using the DPD and the HPA method has significant drawbacks. In addition, in terms of the efficiency of the power amplifier, the related-art DPD and HPA method cannot actively produce a change in a peak-to-average ratio (PAR).

### SUMMARY OF THE INVENTION

An object of the invention is to solve at least the above problems and/or disadvantages and to provide at least the advantages described hereinafter.

Another object of the present invention is to provide a linearization apparatus and method which are capable of implementing a low cost, high-performance linearization technique while simultaneously improving the efficiency of a power amplifier during multi-carrier transmission of a base station.

To achieve at least the above objects in whole or part, there is provided a linearization apparatus of a base station which, in accordance with one embodiment, includes: a digital transceiver (DTRA) assembly unit for receiving a signal coming from an upper channel card of a base station, performing filtering, pre-distortion and RF processing on the signal; a power amplifier for amplifying an output of the DTRA and outputting it; and a digital pre-distortion (DPD) unit for receiving an output of the power amplifier and performing correction, inverse FFT FIR filter estimation on the output according to a bulk gain, a bulk phase and a bulk delay, so that correction can be made at the DTRA.

In accordance with another embodiment, the present invention provides a linearization method of a CDMA base station comprising: inputting a training signal and calculating a correction value according to a bulk gain, a bulk phase and a bulk delay for correction of a static nonlinear component; performing inverse FFT FIR filter estimation; and receiving and filtering signals coming from an upper channel card; coupling filtered signals; performing digital pre-distortion controlled by the training; and amplifying power and transmitting it.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram showing a related-art linearization apparatus of a CDMA base station;

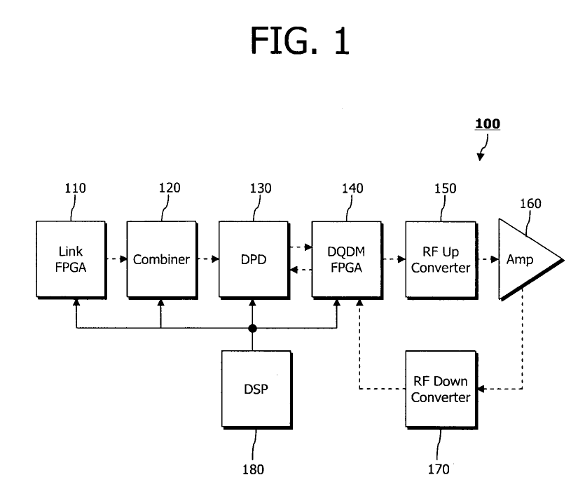

FIG. 2 is a graph of a spectrum mask showing performance measurement results of the related art apparatus of FIG. 1;

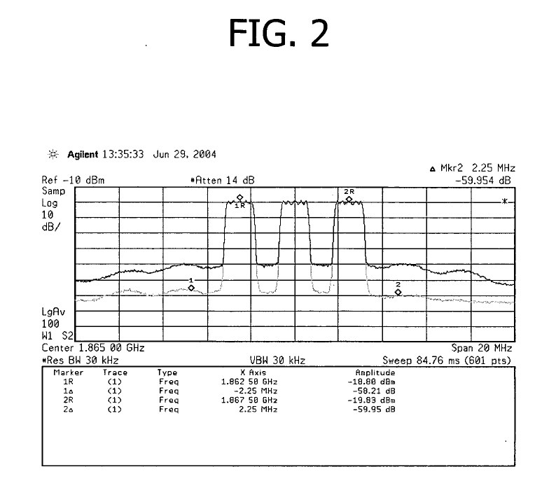

FIG. 3 is a diagram showing an exemplary linearization apparatus adapted for use in a base station in accordance with one embodiment of the present invention;

FIG. 4 is a diagram showing an exemplary linearization apparatus with a separated DPD unit in accordance with one embodiment of the present invention;

FIG. 5 is a flow chart showing steps included in an exemplary linearization method adapted for use in a base station in accordance with one embodiment of the present invention; and

FIG. 6 is a graph showing an error convergence effect of each stage in accordance with at least one embodiment of the present invention.

### DESCRIPTION OF THE INVENTION AND/OR BEST MODE

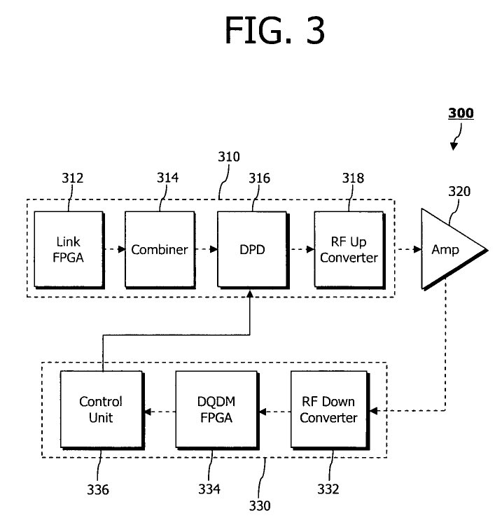

FIG. 3 shows a linearization apparatus 300 adapted for use, for example, in a base station in accordance with one embodiment of the present invention.

This apparatus includes a digital transceiver assembly (DTRA) unit 310, an amplifier 320, and a digital pre-distortion (DPD) unit 330. The DTRA unit receives a signal from an upper channel card of a base station, and performs filtering, pre-distortion and RF processing on the signal. The amplifier 320 amplifies power of an output of the DTRA unit 310. And, the digital pre-distortion (DPD) unit 330 receives an output of amplifier 320, and performs correction and inverse fast Fourier transform finite impulse response (FFT FIR) filter estimation on the signal according to parameters including, for example, bulk gain, bulk phase, and bulk delay so that correction can be made in the DTRA.

The DTRA unit includes a link FPGA 312, a combiner 314, a DPD 316, and an RF up-converter 318. The FPGA receives and filters the signal from the upper channel card of the base station. The combiner 314 combines signals output from the link FPGA. The DPD 316 performs correction according to bulk gain, bulk phase, bulk delay and performs digital pre-distortion according to an inverse FFT FIR filter estimation with respect to an output of the combiner. The RF up-converter 318 receives an output of the DPD, converts it into an analog signal, up-converts the analog signal into an RF signal, and outputs the result to amplifier 320.

The DPD unit includes an RF down-converter 332, a DQDM FPGA 334, and a control unit 336. The RF down-converter receives the amplified signal from amplifier 320, converts it into a digital signal, and performs frequency down-conversion on the digital signal. The DQDM (Digital Quadrature Demodulation) FPGA 334 performs DQDM to sample an IF signal input from the RF down-converter 332 into double and outputs it. And, controller 336 outputs a control signal based on the correction made according to bulk gain, bulk phase, bulk delay and the inverse FFT FIR filter estimation to the DPD 316 of the DTRA unit.

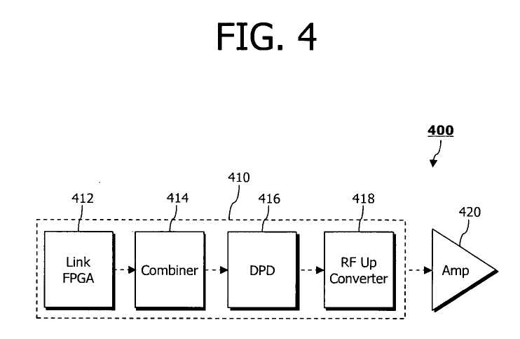

The DPD unit may be formed, for example, as a single sheet jig board. When formed in this manner and when training is sufficiently performed, e.g., when training is completed, DPD unit 330 may be separated from the linearization apparatus. As a result, the linearization apparatus when actually mounted in the base station system may include only the DTRA unit 410 and the amplifier 420, as shown in the example of FIG. 4.

The DPD unit may also be used to tune a plurality of DTRA units 310 with one sheet of jig board. When used in this manner and when the linearization apparatus is mounted in the actual base station, the DPD unit may be removed to thereby reduce feedback path. This has the effect of lowering costs, and also allows the construction of the board to be simplified. This will reduce the defect rate and may even reduce interference from the feedback path.

The RF down-converter 332 and the controller 336 of the DPD may be blocks formed in a closed loop. This loop may then be used to calculate an initial delay or an IMD (inter Modulation Distortion) component for adaptively performing operations. Accordingly to one embodiment, the RF down-converter 332 and controller 336 may be made of a single jig and may be excluded when the linearization apparatus is actually mounted in the base station.

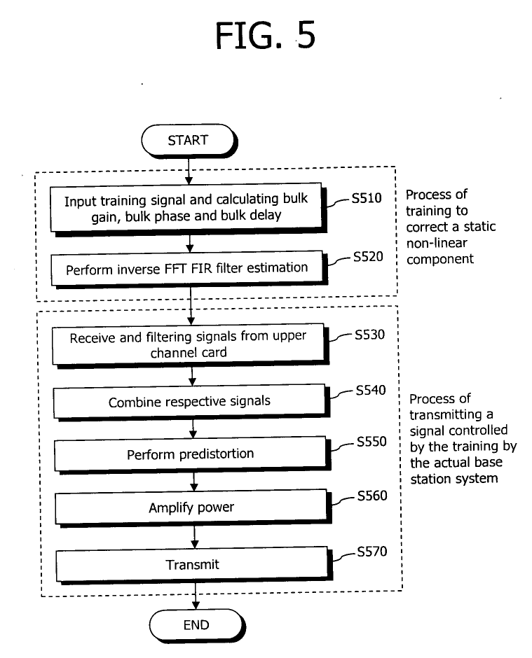

FIG. 5 is a flow chart showing steps included in a linearization method performed in a CDMA base station in accordance with one embodiment of the present invention. This method includes a process (steps S510 and S520) of performing training to correct a static non-linear component, and a process (steps S530 to S570) of transmitting a signal controlled by the training from the actual base station system. The process of performing training to correct the static non-linear component may involve inputting a training signal and then calculating a correction value based on the bulk gain, bulk phase and the bulk delay (step S510), as well as performing inverse FFT FIR filter estimation (step S520).

The process of transmitting a signal controlled by the training may include receiving and filtering signals coming from the upper channel card (step S530), combining the filtered signals (step S540), performing digital predistortion controlled by the training (step S550), and amplifying its power and transmitting it (steps S560 and S570). The process will now be described in greater detail with reference to FIGS. 3 and 4.

DTRA unit 310 and DPD unit 330 may be connected to form a closed loop. Correction values corresponding to bulk gain, bulk phase and bulk delay may be calculated by inputting a digital training signal to DPD 316. These calculations may be performed using the following equations:

$$\begin{matrix}R ( τ ) = \vert {\sum }_{t = - T}^{T} {V}_{m} ( t ) {{V}_{f} ( t - τ )}^{*} \vert & ( 1 ) \\ θ = Arg ( ( {\sum }_{t = - T}^{T} {V}_{m} ( t ) {{V}_{f} ( t - τ )}^{*} ) {\vert}_{τ = {R}_{max}} ) & ( 2 ) \\ G = \sqrt{\frac{E \{ {{V}_{m} ( t )}^{2} \}}{E \{ {{V}_{f} ( t )}^{2} \}}} & ( 3 )\end{matrix}$$

where ‘R’ is a bulk delay time, θ is a bulk phase, ‘G’ is a bulk gain, ‘T’ and ‘t’ are time, Vm(t) is an input signal, Vf(t) is a feedback signal, and ‘E’ is energy.

Once the three parameters of bulk delay time, bulk phase and bulk gain are calculated, scaled, and rotated, a delay calculation for matching the feedback signal Vf(t) of the amplifier 320 to the input signal Vm(t) can be performed. This may be implemented, for example, as a simple complex gain and bulk radiowave delay filter. Once the foregoing calculations are made, an estimate output waveform of amplifier 320 is synchronized, and amplitude and phase are matched.

The second process involves performing inverse FFT FIR filter estimation (step S520). In order to implement a function using frequency as a variable in a broadband frequency zone at a level of gain, amplitude and phase are calculated by sweeping a narrowband signal to the entire band. A precise function may then be calculated using the frequency as a variable by applying signals, each with a sufficient size and narrow resolution taking the power beyond a saturation region of amplifier 320 into consideration along with PAR.

The response of a gain vector (k) and a phase according to each frequency are one-to-one mapped with each input digital signal, and a corresponding calculation can be obtained by equation shown below:

$$\begin{matrix}\begin{matrix}Gain Response \\ {k}_{frequency \cdot amplitude}\end{matrix} = \sqrt{\frac{E ( {V}_{f} ( t ) {{V}_{f} ( t )}^{*} )}{E ( {V}_{m} ( t ) {{V}_{m} ( t )}^{*} )} \vert} {V}_{m} ( t ) = Amplitude & ( 4 ) \\ \begin{matrix}Phase Response \\ {k}_{frequency \cdot amplitude}\end{matrix} = Arg ( {V}_{f} ( t ) {{V}_{f} ( t )}^{*} ) \vert {V}_{m} ( t ) = Amplitude & ( 5 )\end{matrix}$$

As noted in the above equations, individual FIR filters expressing each response of a broadband frequency of the amplifier 320 take a vector (*) for a matrix through cross dimension of a constant (Arg) amplitude and a variation frequency. In addition, a filter tab is calculated through the inverse fast Fourier transform over a time axis.

The process is repeated according to the magnitude of 128 of every input signal. Such a filter set may then be stored as a power amplifier model in a RAM (Random Access Memory) of the DPD 316.

Thus, for adaptive operation following the aforementioned series of processes, the DTRA unit 310 performs a process (namely, a training process for correcting a static component) to lower an error floor of the power amplifier model.

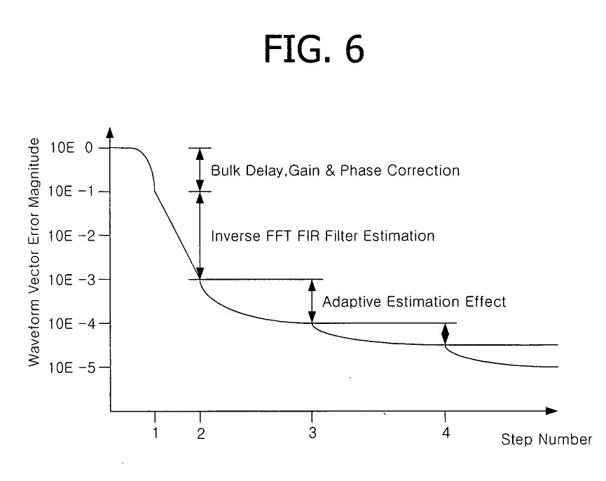

FIG. 6 is a graph showing an error convergence effect attained at each stage in accordance with one embodiment of the present invention. Here, it can be seen that an error magnitude may be lowered to 10E-3 only with “Bulk Delay, Gain & Phase Correction” of a first step and “Inverse FFT FIR Filter Estimation” of a second step. Thus, actual application of the present invention to the base station does not have the problems of the related art, even when performing up to step No. 2.

Also, it is noted that temperature and an IMD variation amount may be considered to be infinitesimal based on characteristics of a transistor die of the power amplifier 20. This is a small amount of generated error. In order to compensate for it, an existing LP can be used. However, in the LPA structure used thus far, although the capacity of the LPA is reduced to half or more, its performance is not affected as observed through an experimentation as shown in FIG. 6. That is, when the LPA for which up to step No. 2 was performed is used, it has been verified that the existing power amplifier 320 of 30 Watt rated capacity can be used at 70 Watt or above. This has been confirmed through the experimentation. The problem of the time delay for compensating a non-linear component, which can only be recognized as a native characteristic because the DPD 316 is operated in a non-real time and its operation frequency is limited, can be solved.

When training has been sufficiently performed, the linearization apparatus 400 can actually be mounted in the system, excluding DPD unit 330 connected with DTRA unit 310, as only the DTRA unit 410 and the amplifier 420 as shown in FIG. 4. Accordingly, its internal blocks are simplified, unit costs can be reduced, and fast error convergence time can be obtained. The linearization apparatus 400 mounted in the base station system performs steps S530 to S570 of receiving signals coming from the upper channel card and transmitting them.

In this manner, the efficiency of the power amplifier can not only be improved in combination with the feedforward method but also implement the high performance linearization technique. This is possible by supplementing the digital pre-distortion function of the DTRA which handles the linearization enhancement function in the multi-carrier transmission of the base station, which has been weak for memory effect.

The linearization apparatus and method of the present invention has advantages. For example, the digital pre-distortion function of the DTRA which handles the linearization enhancement function in the multi-carrier transmission of the base station, which has been weak for a memory effect, can be supplemented. As a result, the efficiency of the power amplifier can be improved in combination with the feedforward method, and a high performance linearization technique can also be implemented.

Additional advantages of the present invention include:

1) The linearization performance of the power amplifier can be maximized

2) The unit cost of the RF processing block can be reduced

3) Preference to the LPA structure of those interested in the related field can be satisfied

4) The power efficiency of the power amplifier can be increased

5) The unit cost can be reduced by removing the feedback path of the transceiver and the price competitiveness can be obtained

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A linearization apparatus, comprising:
a digital transceiver (DTRA) assembly unit which receives a signal from an upper channel card of a base station, and performs filtering, pre-distortion and RF processing on the signal;
a power amplifier which amplifies an output of the DTRA; and
a digital pre-distortion (DPD) unit which connects an output of the power amplifier and performs pre-distortion based on inverse FFT FIR filter estimation according to bulk gain, bulk phase and bulk delay.

2. The apparatus of claim 1, wherein the DTRA unit comprises:
a link FPGA for receiving and filtering the signal from the upper channel card of the base station;
a combiner for combining signals output from the link FPGA;
a DPD for performing correction according to said bulk gain, bulk phase, bulk delay and digital pre-distortion according to an inverse FFT FIR filter estimation with respect to an output of the combiner; and
an RF up-converter for receiving an output of the DPD, converting it into an analog signal, up-converting the analog signal into an RF signal, and outputting it to the amplifier.

3. The apparatus of claim 1, wherein the DPD unit comprises:
an RF down-converter for receiving the amplified signal from the power amplifier, converting it into a digital signal, and performing down-conversion on the digital signal; and
a controller for receiving an output of the RF down-converter, and outputting a control signal according to the correction made based on the bulk gain, the bulk phase, the bulk delay and the inverse FFT FIR filter estimation to the DPD of the DTRA unit.

4. The apparatus of claim 3, wherein the DPD unit calculates a correction value according to the bulk gain, the bulk phase and the bulk delay through a complex gain and a bulk radiowave delay filter.

5. The apparatus of claim 1, when the DPD unit is separated from the linearization apparatus when training is completed.

6. A linearization apparatus, comprising:
a link FPGA which receives and filters a signal from an upper channel card of a base station;
a combiner which combines signals from the link FPGA;
a DPD which performs correction according to a bulk gain, a bulk phase, a bulk delay and digital predistortion according to an inverse FFT FIR filter estimation with respect to an output of the combiner;
an RF up-converter which converts an output of the DPD into an analog signal and up-converts the analog signal into an RF signal; and
an amplifier which amplifies power of an output of the RF up-converter prior to transmission.

7. The apparatus of claim 6, further comprising:
an RF down-converter for converting the amplified signal from the power amplifier into a digital signal and for performing down-conversion on the digital signal; and
a controller which receives an output of the RF down-converter, and outputs a control signal according to the correction based on bulk gain, bulk phase, bulk delay, and an inverse FFT FIR filter estimation to the DPD of the DTRA unit.

8. A linearization method of a base station comprising:
performing training to correct a static nonlinear component; and
filtering and amplifying a signal controlled by the training;
transmitting the filtered and amplified signal from a base station system.

9. The method of claim 8, wherein performing training comprises:
inputting a training signal and calculating a correction value according to bulk gain, bulk phase and bulk delay; and
performing inverse FFT FIR filter estimation.

10. The method of claim 9, wherein the step of calculating the correction value according to the bulk gain, the bulk phase and the bulk delay comprises:
calculating parameters of the bulk gain, the bulk phase and the bulk delay time; and
performing a scaled, rotated and delay calculation for matching a feedback signal to an input signal.

11. The method of claim 8, wherein the step of transmitting a signal comprises:
receiving and filtering signals transmitted from an upper channel card;
combining the filtered signals;
performing digital predistortion controlled by the training; and
amplifying power of the predistorted signal and transmitting it.

12. A linearization apparatus, comprising:
a digital transceiver circuit which RF processes a signal from an external source;
an amplifier which amplifies an output of the digital transceiver circuit; and
a first digital pre-distortion circuit which pre-distorts an output of the amplifier based on an inverse FFT FIR filter estimation based on one or more predetermined parameters.

13. The apparatus of claim 12, wherein the external source is an upper channel card of a base station.

14. The apparatus of claim 12, wherein said predetermined parameters include bulk gain, bulk phase, and bulk delay.

15. The apparatus of claim 12, wherein the digital transceiver includes:
a link FPGA for filtering the signal from the external source;
a combiner to combine signals output from the link FPGA;
a second digital pre-distortion circuit which performs correction according to said one or more parameters and digital pre-distortion based on inverse FFT FIR filter estimation with respect to an output of the combiner; and
an RF up-converter which converts an output of the second digital pre-distortion circuit into an analog signal, up-converts the analog signal into an RF signal, and output the RF signal to the amplifier.

16. The apparatus of claim 13, wherein the first digital pre-distortion circuit comprises:
an RF down-converter which converts the amplified signal from the power amplifier into a digital signal and then down-converts the digital signal; and
a controller which receives an output of the RF down-converter and outputs a control signal according to the correction made based on said one or more predetermined parameters and the inverse FFT FIR filter estimation.

17. The apparatus of claim 16, wherein the first pre-distortion circuit calculates the correction value based on bulk gain, bulk phase and bulk delay through a complex gain and a bulk radiowave delay filter.
